(19) United States
(12) Patent Application Publication
(10) Pub. No.: US 2026/0276433 A1
(43) Pub. Date: Sep. 17, 2026

(54) A SENSING SYSTEM FOR DETERMINING A PARAMETER OF A SET OF ANIMALS

(71) Applicant: SIGNIFY HOLDING B.V, EINDHOVEN (NL)

(72) Inventors: MARC ANDRE DE SAMBER, LOMMEL (BE); HARRY BROERS, 'S HERTOGENBOSCH (NL); AARON BENJAMIN STEPHAN, CHANHASSEN, MN (US); CURTIS ALLEN LEYK, ALBANY, MN (US)

(21) Appl. No.: 19/168,956

(22) PCT Filed: Mar. 19, 2024
(86) PCT No.: PCT/EP2024/057249

§ 371 Date: Sep. 25, 2025

Related U.S. Application Data
(60) Provisional application No. 63/455,019, filed on Mar. 28, 2023.

(30) Foreign Application Priority Data
Apr. 18, 2023 (EP) 23168386.3

(51) Int. Cl. G01G 17/08; A01K 45/00

(52) U.S. Cl. CPC G01G 17/08; A01K 45/00

(57) ABSTRACT

The invention provides a sensing system for determining a parameter of a set of animals, wherein the sensing system comprises a scale, a range sensor, and a controller; wherein the scale comprises a measurement surface suitable for receiving an animal of the set of animals, wherein the range sensor has a Field-of-View directed to said measurement surface; wherein the scale is configured to measure a weight of each respective animal of the set of animals received on the measurement surface, and output a respective weight signal indicative of said measured weight; wherein the range sensor is configured to measure a height of each respective animal of the set of animals received on the measurement surface, and output a respective height signal indicative of said measured height; wherein the controller is configured to obtain each respective weight signal and each respective height signal, and determine the parameter of the set of animals based on said measured weights and said measured heights.

### FIELD OF THE INVENTION

The invention relates to sensing system for determining a parameter of a set of animals. The invention further relates to a corresponding method. The invention may further relate to a kit of parts.

### BACKGROUND OF THE INVENTION

Agriculture has become more industrialized in modern communities. This is also the case for animal farming. The number of animals, the associated infrastructures, and the various growing methods are scaled up to achieve economically viable production of food at relatively low price levels.

It is of high relevance to monitor the development and growth of large population of livestock animals, and compare said growth with expected growth curves. This is however challenging in industrial farms with large animal populations, because a farmer cannot rely anymore on conventional practices of visual observation and performing hand-evaluations (i.e. picking up a number of animals for manual evaluation).

Such needs are at least partly met by automated weighing scales in the farm, such as for example in the rearing of poultry, wherein the automated weighing scales randomly measure the weight of the bird population, thereby approximating an average weight of the bird population. However, weight alone cannot provide a full picture of the physiological development and health of the animals.

Hence, there is still a significant need for more efficient and automated methods that track both the growth and the physiological development of livestock animals, in particularly (large) groups of animals.

### SUMMARY OF THE INVENTION

It is an object of the invention to provide an improved sensing system, which at least alleviates the problems and disadvantages mentioned above. Thereto, the invention is defined by the appended claims. Thereto, the invention provides a sensing system for determining a parameter of a set of animals, wherein the sensing system comprises a luminaire, a scale, a range sensor, and a controller; wherein the range sensor is part of the luminaire; wherein the scale comprises a measurement surface suitable for receiving an animal of the set of animals, wherein the range sensor has a Field-of-View directed to said measurement surface; wherein the scale is configured to measure a weight of each respective animal of the set of animals received on the measurement surface, and output a respective weight signal indicative of said measured weight; wherein the range sensor is configured to measure a height of each respective animal of the set of animals received on the measurement surface, and output a respective height signal indicative of said measured height; wherein the controller is configured to obtain each respective weight signal and each respective height signal, and determine the parameter of the set of animals based on said measured weights and said measured heights.

Hence, the present invention provides a sensing system comprising a scale, a range sensor, and a controller. The scale may be phrased as a weighing scale. The scale measures the weight of each respective animal of the set of animals received on its measurement surface, and outputs a weight signal (for each measurement or set of measurements) indicative of said measured weight. However, weight alone may not be sufficient to determine parameters on the physiological development of livestock animals.

Hence, the sensing system according to the present invention comprises a range sensor. The range sensor has a Field-of-View directed to said measurement surface of the scale. Therefore, the range sensor is configured to measure a height of each respective animal of the set of animals received on the measurement surface (thus passing its Field-of-View), and output a height signal (for each measurement or set of measurements) indicative of said measured height. The range sensor may alternatively be phrased as an installed range sensor.

Moreover, the sensing system according to the present invention comprises a controller configured to obtain each (one of) said respective weight signal and each (one of) said respective height signal, i.e. for each respective animal received on the measurement surface. Said obtaining may mean receiving or retrieving. The controller is also configured to determine the parameter of a set of animals based on said measured weights and said measured heights.

Thus, for each respective animal of the set of animals, the weight and height are measured in combination, and the resulting weights and heights are subsequently used by the controller to determine the parameter of the set of animals. Since weight and height are co-measured, the present invention enables to monitor the physiological and/or the corporeal development of the set of animals, such as for example a flock of poultry.

For example, knowing the weight and height of each individual animal, parameters such as muscularity and/or body mass index may be determined for each individual animal. Namely, considering poultry, a smaller bird (indicated by height) having a higher weight is more muscular than a larger bird (indicated by height) having a lower weight (i.e. this bird is skinnier).

Since the set of animals may be part of a larger group of animals, the determining of the parameter of the set of animals enables an approximation for the larger group of animals, which approximation may become (statistically) even more accurate as the set of animals (received on the measurement surface) increases. For a group of animals, such as a flock of chicken, the present invention may be particularly advantageous to determine the growth and physiological development of animals on a group (i.e. flock) level.

As mentioned, the range sensor is configured to measure a height of each respective animal of the set of animals received on the measurement surface (thus passing its Field-of-View), and output a height signal (for each measurement or set of measurements) indicative of said measured height. The range sensor may thereby be arranged at a predetermined distance from the measurement surface of the scale. A person skilled in the art would understand how to calibrate such a range sensor. The range sensor can therefore measure (or: derive, or: deduce) the height of the respective animal received on the measurement surface. Namely, the absolute difference in range between a situation wherein no respective animal is received on the measurement surface of the scale and a situation wherein a respective animal is received on the measurement surface may be considered the height of an animal. Preferably, a centerline of the Field-of-View of the range sensor is substantially orthogonal to the measurement surface. In case the scale surface is lowered due to the weight of an animal, said lowering can be easily modeled and compensated for since the weight is measured.

In an embodiment, the set of animals is a flock of birds. In an embodiment, the set of animals is a flock of chicken. Said birds or flock of birds may alternatively be a flock of one or more of: Turkeys, Ducks, Geese, Pheasant, Quail, Guinea Fowl, Heritage Breed Chickens, Pet Birds, Songbirds.

In an alternative embodiment, said set of animals may be cattle. In an alternative embodiment, said set of animals may be swine, cow, etc.

Said height may be a height indicating an animal physiology, such as a maximum height of the head, or height of the back of the respective animal.

In an embodiment, the controller is configured to output an output signal based on said determined parameter. For example, said output signal may be a control signal configured: to display a user interface element indicative of said parameter on a user interface, to store said parameter in a memory of a remote third device, to notify a further device of said parameter, to actuate a farm equipment such as a feeder or watering nipple. The output signal may be an alarm signal configured to actuate an alarm or display an alarm signal if said parameter exceeds a predetermined limit. Alternatively, the output signal may be a lighting control signal based on said parameter, for example to control a lighting device to output a lighting characteristic based on said parameter. The lighting characteristic may be an animal lighting recipe (i.e. spectrum). For example, the controller may output an lighting control signal upon based on said parameter, said lighting control signal configured to cause a lighting device to render a lighting characteristic comprising blue light at a blue light intensity, and/or ultraviolet light at an ultraviolet light intensity. Such blue and/or ultraviolet light may cause poultry to feed more effectively and efficiently as feed is more visible.

In an embodiment, the scale is configured to convey a trigger signal to the range sensor when an animal of the set of animals is received on the measurement surface; wherein the range sensor is configured to measure the height of each respective animal of the set of animals received on the measurement surface upon receiving said trigger signal.

As the measured weight may determine that a (single) respective animal is received on the measurement surface of the scale, a ‘good’ measurement of combined weight and height can be obtained, by conveying a trigger signal to the range sensor, the trigger signal being configured to control the range sensor to perform said height measurement.

For example, the scale may convey said trigger signal upon the scale being activated by the weight of said animal, i.e. when an animal of the set of animals is received.

Furthermore, in aspects, for example, the scale may comprise an (embedded) accelerometer (relative to the measurement surface) so as to monitor the dynamics of the measurement surface that receives the respective animal of the set of animals; and the scale may be configured to convey said trigger signal upon the accelerometer of the scale being triggered. Other trigger mechanism may be envisioned similarly.

Yet in further aspects, the scale is configured to convey a trigger signal to the range sensor when an animal of the set of animals is received on the measurement surface and the measured weight of the respective animal does no longer fluctuate outside a predetermined range (i.e. the animal is substantially standing still on the measurement surface).

In an embodiment, the scale comprises a radiofrequency transmitter configured to convey said trigger signal to the range sensor. Such a radiofrequency transmitter may for example a Bluetooth transmitter, a ZigBee Transmitter, an RFID or NFC transmitter, a Li-Fi transmitter, or a Wi-Fi transmitter. Hence, in an embodiment, the radiofrequency transmitter conveys said trigger signal wirelessly to the range sensor via one of: Bluetooth, ZigBee, Wi-Fi, Matter.

In an embodiment, the range sensor is a single-pixel Time-of-Flight (ToF) sensor. Such an embodiment may be advantageous, because a single-pixel Time-of-Flight (ToF) sensor is cost-effective range sensor that typically measures a single value of range, but which single value of range may be sufficient to determine the height of each respective animal of the set of animals received on the measurement surface. More advanced single-pixel Time-of-Flight (ToF) sensors may measure multiple distances with (or within) the single-pixel by implementing various signal processing techniques.

In an embodiment, the range sensor may be configured to measure (or: determine) a maximum height of each respective animal of the set of animals received on the measurement surface. For example, whilst or when a respective animal of the set of animals is received on the measurement surface, and optionally the scale conveys a trigger signal, the range sensor may measure a plurality of heights of set respective animal and determine a maximum height from said measured plurality of heights, thereby measuring a maximum height.

The present invention provides a sensing system for determining a parameter of a set of animals. Said parameter may be indicative of the health, growth, and/or physiological development of the set of animals. The set of animals is preferably a flock of birds, such as a flock of chicken.

In an embodiment, the parameter of the set of animals comprises a distribution and/or table of the measured weights versus the measured heights.

In an embodiment, the controller is configured to determine a respective function value for each respective animal of the set of animals by applying a function that is using the measured weight of each respective weight signal and the measured height of each respective height signal; and wherein the controller is configured to determine the parameter of the set of animals by taking an average or mean of said determined function values.

In an embodiment, the parameter of the set of animals is an average or mean muscularity value of the set of animals.

In an embodiment, the parameter of the set of animals is an average or mean Body Mass Index (BMI) value of the set of animals.

The parameter of the set of animals may be determined during a first time period and during a second time period subsequent to the first time period. This enables a comparison in time, hence to derive conclusions on the development of said parameter. For example, if said parameter is e.g. average BMI value of the set of animals, determining the average BMI value during the first time period and the average BMI value during the subsequent second time period enables to determine the (temporal) development of the set of animals for this particular parameter.

In an embodiment, the controller is configured to: determine a first sub-parameter of the set of animals based on measured weights and measured heights obtained during a first time period; to determine a second sub-parameter of the set of animals based on measured weights and measured heights obtained during a second time period; and determine the parameter of the set of animals based said first sub-parameter and said second sub-parameter.

In an embodiment, the parameter of the set of animals is a growth parameter, wherein the controller is configured to: determine the first sub-parameter of the set of animals by averaging function values of a function that is using the measured weights and measured heights obtained during the first time period; determine the second sub-parameter of the set of animals by averaging function values of a function that is using the measured weights and measured heights obtained during the second time period; and determine the parameter of the set of animals by determining a difference between said first sub-parameter and said second sub-parameter.

The range sensor may be arranged separately from the scale. In an embodiment, the sensing system comprises a luminaire; wherein the range sensor is part of the luminaire. Such an embodiment is advantageous, because a luminaire can provide a power and/or a data backbone to the range sensor, thereby benefitting from a lighting infrastructure. Namely, scales may be positioned relative to the luminaire, such that the range sensor in the luminaire may have a Field-of-View to the measurement surface of the scale.

In an embodiment, the luminaire is configured to power the range sensor, and/or convey control signals to the range sensor.

In an embodiment, the luminaire comprises a light source; wherein the controller is configured to control the light source to emit a lighting characteristic based on the determined parameter of the set of animals.

In an alternative embodiment, the range sensor may be a multi-pixel Time-of-Flight (ToF) sensor. Due to the multiple pixels, such multi-pixel ToF sensor may also be able to distinguish pixels with a relatively higher value (i.e. pixels having a value exceeding a predefined threshold value) relative to background pixels, which may have a relatively low or constant value. The background pixels may correspond to the measurement surface being at a constant distance from the range sensor. Hence, the 2D footprint resulting from the pixels with a relatively higher value may be indicative of a size of the respective animal on the measurement surface. Therefore, a multi-pixel Time-of-Flight (ToF) sensor may not only be able to determine a height of a respective animal on the measurement surface, but also determine its contour or size.

Therefore, in an embodiment alternative to the embodiment comprising a single-pixel Time-of-Flight sensor, the range sensor is a multi-pixel Time-of-Flight (ToF) sensor, wherein the range sensor is further configured to determine a size of each respective animal of the set of animals received on the measurement surface, and output a respective size signal indicative of said measured size; wherein the controller is configured to obtain each respective weight signal and each respective height signal and/or each respective size signal; and determine the parameter of the set of animals based on said measured weights and said measured heights and/or said measured sizes.

In an alternative embodiment, the range sensor may be one of: a LIDAR, a laser scanner, a (FMCW) radar, structured light stereo vision sensor.

In aspects, throughout the application, said height may be a vertical dimension. Hence, the range sensor may be configured to measure a vertical dimension of each respective animal of the set of animals received on the measurement surface; the range sensor outputting a respective vertical dimension signal indicative of said measured vertical dimension; wherein the controller may be obtaining each respective weight signal and each respective vertical dimension signal; the controller determining the parameter of the set of animals based on said measured weights and said measured vertical dimension signals. Said vertical dimension may for example be the height of the respective animal.

In aspects, the range sensor has a Field-of-View directed to said measurement surface and covers at least said measurement surface, such that the measurement surface is always within said Field-of-View. The range sensor may optionally measure, if applicable, a region directly surrounding the scale.

In aspects, the controller may be configured to obtain each respective weight signal and each respective height signal; and subsequently disregard each respective weight signal that comprises a measured weight outside a predetermined weight range and disregard each respective height signal that comprises a measured height outside a predetermined height range; and subsequently determine the parameter of the set of animals based on said measured weights and said measured heights that are not disregarded. Such aspects may filter out outliers in the measured heights and/or weights. This may improve the approximation of the parameter for the set of animals.

It is further an object of the invention to provide an improved method, which at least alleviates the problems and disadvantages mentioned above. Thereto, the invention provides a method of determining a parameter of a set of animals, the method being performed by a sensing system comprising a scale, a range sensor, and a controller; wherein the scale comprises a measurement surface suitable for receiving an animal of the set of animals, wherein the range sensor has a Field-of-View directed to said measurement surface; wherein the method comprises: the scale measuring a weight of each respective animal of the set of animals received on a measurement surface; the scale outputting a respective weight signal indicative of said measured weight; the range sensor measuring a height of each respective animal of the set of animals received on the measurement surface; the range sensor outputting a respective height signal indicative of said measured height; the controller obtaining each respective weight signal and each respective height signal; the controller determining the parameter of the set of animals based on said measured weights and said measured heights. Thereby, advantages and/or embodiments applying to the sensing system according to the invention may mutatis mutandis apply to said method according to the invention.

It is further an object of the invention to provide an improved kit of parts, which at least alleviates the problems and disadvantages mentioned above. Thereto, the invention provides a kit of parts for determining a parameter of a set of animals, wherein the kit of parts comprises a scale according to the invention, a controller according to the invention, and a luminaire according to the invention; wherein the scale comprises a measurement surface suitable for receiving an animal of the set of animals, wherein the scale is configured to measure a weight of each respective animal of the set of animals received on the measurement surface, and output a respective weight signal indicative of said measured weight; wherein the luminaire comprises a range sensor, wherein the range sensor has a Field-of-View directed to said measurement surface, wherein the range sensor is configured to measure a height of each respective animal of the set of animals received on the measurement surface, and output a respective height signal indicative of said measured height; wherein the controller is configured to obtain each respective weight signal and each respective height signal, and determine the parameter of the set of animals based on said measured weights and said measured heights. In embodiments, the luminaire may also comprise the controller.

### BRIEF DESCRIPTION OF THE DRAWINGS

The invention will now be further elucidated by means of the schematic non-limiting drawings:

FIG. 1 depicts schematically an embodiment of a sensing system according to the invention;

FIG. 2 depicts schematically a schematic determination of a parameter according to the invention;

FIG. 3 depicts schematically an embodiment of a sensing system according to the invention;

FIG. 4 depicts schematically a method according to the invention.

### DETAILED DESCRIPTION OF THE EMBODIMENTS

In the rearing of livestock animals, it is of value to monitor the development and growth of large population of livestock animals. This development and growth can subsequently be compared to expected development and growth curves. This is however challenging in industrial farms with large animal populations, such as poultry farms for example, because a farmer cannot rely anymore on conventional practices of visual observation and performing hand-evaluations.

Even though automated weighing scales are currently being deployed in such farms, wherein the automated weighing scales randomly measure the weight of individual birds, the measurement of weight alone cannot provide a full picture of the physiological development and health of the larger set of animals.

Hence, there is still a significant need for more efficient and automated methods that track both the growth and the physiological development of livestock animals, in particularly (large) groups of animals, such as poultry. The present invention provides an improved sensing system to meet these needs.

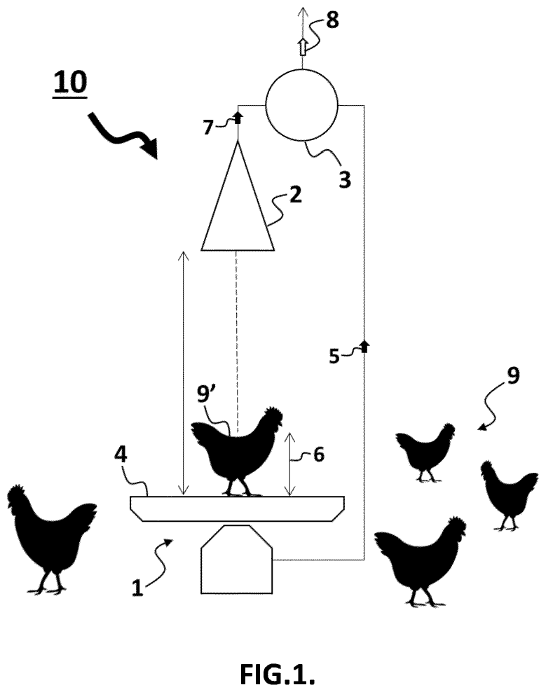

FIG. 1 depicts schematically, by non-limiting example, an embodiment of a sensing system 10 according to the invention. The sensing system 10 comprises a scale 1, a range sensor 2, and a controller 3. These parts of the sensing system 10 are in communication with each other, or communicatively coupled.

The sensing system 10 is arranged for determining a parameter 8 of a set of animals 9. Here, the set of animals 9 is a flock of chickens. Alternatively, the set of animals may be any other flock of birds, for example as mentioned in this application. Yet alternatively, said set of animals may be cattle, or pigs.

Referring to FIG. 1, the scale 1 comprises a measurement surface 4. The measurement surface 4 may be a substantially planar surface. The measurement surface 4 is suitable for receiving an animal 9′ of the set of animals 9, in other words suitable for receiving a chicken 9′ of the flock of chicken 9. The chickens 9 may thus consecutively and continually step on the scale 1 over the course of time.

The scale 1 measures the weight of each respective animal 9′ of the set of animals 9 that is received on the measurement surface 4. Hence, each time a particular chicken 9′ steps onto the measurement surface 4 of the scale 1, the scale 1 measures the weight of that particular chicken 9′. The scale 1 is further configured to output a respective weight signal 5 indicative of said measured weight. Said weight signal 5 is outputted each time a weight measurement is performed. Alternatively, the scale is configured to periodically output a weight signal indicative of a subset of measured weights of respective chicken received on the measurement surface during subperiod of time.

However, weight alone may not be sufficient to efficiently determine certain parameters on the physiological development of livestock animals, in particular a set of animals.

Still referring to FIG. 1, the range sensor 2 of the sensing system 10 is arranged such that the range sensor 2 has a Field-of-View directed to said measurement surface 4. Hence, the Field-of-View of the range sensor 2 covers the measurement surface 4. In aspects, for example, said range sensor may comprise a Field-of-View having a centerline which is arranged substantially orthogonal to the measurement surface.

The range sensor 2 measures a vertical dimension 6 of each respective animal 9′ of the set of animals 9 received on the measurement surface 4. Here, the vertical dimension is height 6 of the respective animal. Alternatively, said height may be a maximum height of the respective animal. Hence, the range sensor 2 is configured to measure a height 6 of each respective animal 9′ of the set of animals 9 received on the measurement surface 4. The range sensor 2 is further configured to output a respective height signal 7 indicative of said measured height 6.

Said height 6 can be determined because the range sensor 2 measures the range from the range sensor 2 to the measurement surface 4. When a chicken 9′ is received on the measurement surface 4, the measured range becomes less, wherein the difference in measured range is indicative of the height of the chicken 9′ received on the measurement surface 4.

Here, the range sensor 2 is a single-pixel Time-of-Flight (ToF) sensor. Alternatively, the range sensor may be a multi-pixel Time-of-Flight sensor, or LIDAR, or a laser scanner, or radar sensor.

Still referring to FIG. 1, the sensing system 10 according to the invention comprises a controller 3. The controller 3 may either be in wired or wireless communication with the scale 1 and the range sensor 2. The controller 3 obtains each (one of) said respective weight signal 5 and each (one of) said respective height signal 7, i.e. for each respective animal 9′ of the set of animals received on the measurement surface. Said obtaining may mean receiving or retrieving. The controller 3 determines the parameter 8 of the set of animals 9 based on said measured weights and said measured heights.

More specifically, in the present embodiment, the parameter 8 may comprise a distribution and/or table of the measured weights versus the measured heights. The parameter may alternatively comprise a distribution curve. In examples, said parameter may be a scatter plot.

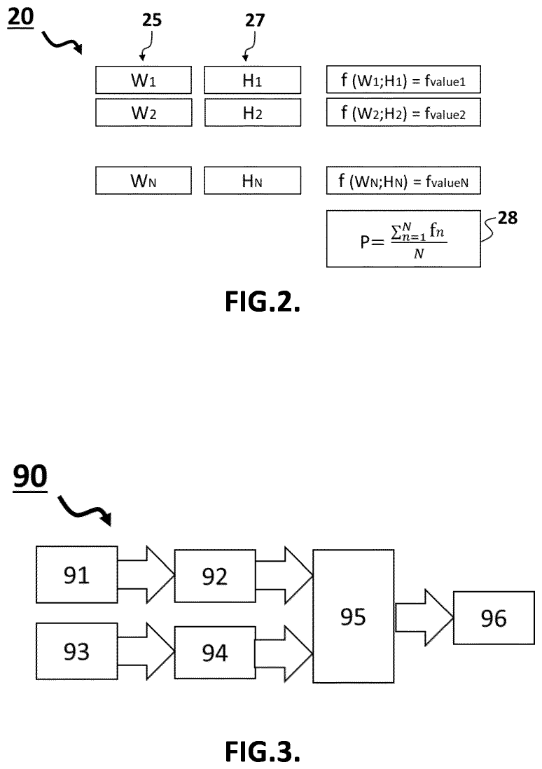

Moreover, optionally, in alternative examples, the controller determines a respective function value (fᵥₐₗᵤₑ) for each respective animal of the set of animals by applying a function (f) that is using the measured weight(s) 25 of each respective weight signal and the measured height(s) 27 of each respective height signal. Thereby, a number (N) of respective animals of the set of animals may be received on the measurement surface of the scale during a certain period of time. The controller then determines the parameter 28 of the set of animals by taking an average or mean of said determined function values (fᵥₐₗᵤₑ) for each of the number (N) of respective animals. FIG. 2 depicts schematically, by non-limiting example, an overview 20 how the measured weight of each respective weight signal and the measured height of each respective height signal are used.

For example, the parameter may be an average or mean muscularity value of the set of animals. For example, the parameter may be an average of mean Body Mass Index (BMI) value of the set of animals. The function is therefore a muscularity function, or a BMI function, which calculate respectively the muscularity value or BMI value for each individual chicken received on the measurement scale based on the measured weight and measured height.

Taking a mean or average of all the chicken received on the measurement scale will render the mean or average of said muscularity value or BMI value. This represents the current muscularity (development) or BMI of the flock of chicken of the present example (i.e. the weight of the respective animal divided by height squared).

Thus, for each respective animal 9′ of the set of animals 9, the weight and height are measured in combination, and the resulting weights and heights are subsequently used by the controller 3 to determine the parameter 8 of the set of animals 9. Since weight and height are co-measured, the present invention enables to monitor the physiological and/or the corporeal development of the set of animals 9.

For example, knowing the weight and height of each individual animal 9′, parameters such as muscularity and/or body mass index may be determined for each individual animal. Namely, a smaller chicken (indicated by height) having a higher weight is more muscular than a larger chicken (indicated by height) having a lower weight (i.e. this chicken is skinnier).

In aspects, the calculated parameter 8 (or parameters) can subsequently be, e.g., averaged, be put in a graph, processed and/or analyzed into further information (or cause control signals to be conveyed further by the controller).

Since the set of animals 9 may be part of a larger group of animals, the determining of the parameter of the set of animals enables an approximation for the larger group of animals, which approximation may become (statistically) even more accurate as the set of animals (received on the measurement surface) increases. Hence, the determined parameter becomes more accurate as more animals step onto the scale 1 during the course of time. For a group of animals, such as a flock of chicken, the present invention may be particularly advantageous to determine the growth and physiological development of animals on a group (i.e. flock) level.

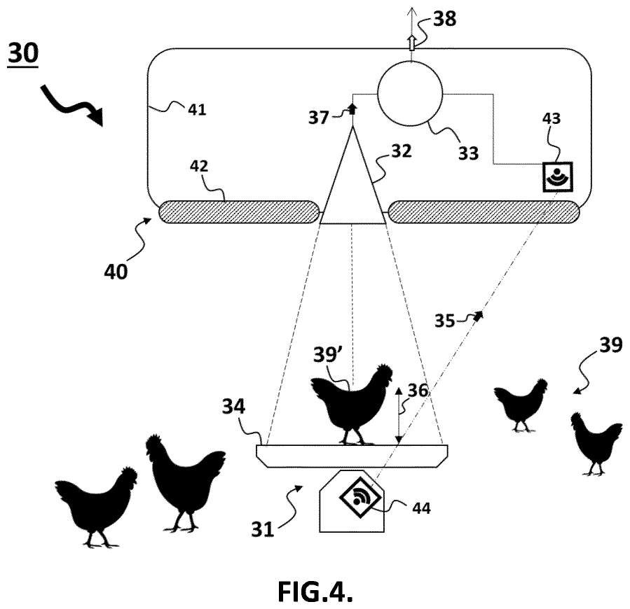

FIG. 4 depicts schematically, by non-limiting example, an embodiment of a sensing system 30 according to the invention. The sensing system 30 comprises a scale 31, a range sensor 32, a controller 33. These parts of the sensing system 30 are in communication with each other, or communicatively coupled.

The sensing system further comprises a luminaire 40. The luminaire 40 comprises a luminaire housing 41. The luminaire 40 comprises the range sensor 32. In other words, the range sensor 32 is part of the luminaire 40. The range sensor 32 is at least partly housed in the luminaire housing 41. The luminaire 40 further comprises at least one light source 42 configured to emit a lighting characteristic. The luminaire further comprises a wireless receiver 43 configured to receive wireless signals.

The sensing system 30 is arranged for determining a parameter 38 of a set of animals 39. Here, the set of animals 39 is a flock of chicken. Alternatively, the set of animals may be any other flock of birds, for example as mentioned in this application.

Referring to FIG. 4, the scale 31 comprises a measurement surface 34 and a wireless transmitter, here a radiofrequency transmitter 44. The measurement surface 34 may be a substantially planar surface. The measurement surface 34 is suitable for receiving an animal 39′ of the set of animals 39, in other words suitable for receiving a chicken 39′ of the flock of chicken 39. The chickens 39 may thus consecutively and continually step on the scale 31 over the course of time.

The scale 31 measures the weight of each respective animal 39′ of the set of animals 39 that is received on the measurement surface 34. Hence, each time a particular chicken 39′ steps onto the measurement surface 34 of the scale 31, the scale 31 measures the weight of that particular chicken 39′. The scale 31 is further configured to output a respective weight signal 35 indicative of said measured weight. Said weight signal 35 is outputted each time a weight measurement is performed.

Furthermore, the scale 31 is configured to convey a trigger signal (not depicted) to the range sensor 32 when an animal 39′ of the set of animals 39 is received on the measurement surface 34. Namely, the radiofrequency transmitter 44 is configured to convey said trigger signal to the range sensor 32. Said trigger signal (not depicted) may be conveyed to the range sensor 32 via the controller 33, as the controller 33, range sensor 32 and the scale 31 are communicatively coupled. For example, referring to FIG. 4, the trigger signal may be received by the wireless receiver 43 of the luminaire 40, which via the controller 31 conveys the trigger signal to the range sensor 32. The radiofrequency transmitter may convey said trigger signal wirelessly to the range sensor via one of: Bluetooth, ZigBee, Wi-Fi, Matter which are known wireless messaging protocols.

Still referring to FIG. 4, the range sensor 32 of the sensing system 30 is arranged such that the range sensor 32 has a Field-of-View directed to said measurement surface 34. Hence, the Field-of-View of the range sensor 32 covers the measurement surface 34. In aspects, for example, said range sensor may comprise a Field-of-View having a centerline which is arranged substantially orthogonal to the measurement surface.

Here, the range sensor 32 is a multi-pixel Time-of-Flight (ToF) sensor, but may alternatively be a single-pixel Time-of-Flight (ToF) sensor comprised by the luminaire.

The range sensor 32 (i.e. the multi-pixel Time-of-Flight sensor) measures a vertical dimension 36 of each respective animal 39′ of the set of animals 39 received on the measurement surface 34. Here, the vertical dimension is height 36 of the respective animal, more specifically the height 36 is a maximum height of the respective animal 39′. For example, the pixel of the multi-pixel Time-of-Flight sensor that is indicative of the largest (maximum) height (value) of said chicken 39′ determines the height 36. Hence, the range sensor 32 is configured to measure a height 36 of each respective animal 39′ of the set of animals 39 received on the measurement surface 34. The range sensor 32 is further configured to output a respective height signal 37 indicative of said measured height 36.

Here, in the present embodiment, by non-limiting example, the range sensor 32 measures the height 36 of each respective animal 39′ of the set of animals 39 received on the measurement surface 34 upon receiving said trigger signal (not depicted).

Said height 36 can be determined because the range sensor 32 measures the range from the range sensor 32 to the measurement surface 34. When a chicken 39′ is received on the measurement surface 34, the measured range becomes less, wherein the difference in measured range is indicative of the height of the chicken 39′ received on the measurement surface 34.

Still referring to FIG. 4, the sensing system 30 according to the invention comprises a controller 33. The controller 33 is also comprised by the luminaire 40. Alternatively, said controller may be remote from the luminaire.

The controller 33 obtains each (one of) said respective weight signal 35 and each (one of) said respective height signal 37, i.e. for each respective animal 39′ received on the measurement surface 34. Said obtaining may mean receiving or retrieving. Here, the weight signal 35 is wirelessly conveyed from said radiofrequency transmitter 44 to the wireless receiver 43 of the luminaire 40. The height signal 37 is conveyed to the controller via a wired connection, as the controller 33 and the range sensor 32 are within the same luminaire 40. The controller 33 determines the parameter 38 of the set of animals 39 based on said measured weights and said measured heights.

More specifically, in the present embodiment, the controller determines a respective function value (fᵥₐₗᵤₑ) for each respective animal of the set of animals by applying a function (f) that is using the measured weight(s) 35 of each respective weight signal and the measured height(s) 37 of each respective height signal. Thereby, a number (N) of respective animals of the set of animals may be received on the measurement surface of the scale during a certain period of time. The controller then determines the parameter 38 of the set of animals by taking an average or mean of said determined function values (fᵥₐₗᵤₑ) for each of the number (N) of respective animals. FIG. 2 depicts schematically, by non-limiting example, an overview how the measured weight of each respective weight signal and the measured height of each respective height signal are used.

For example, the parameter may be an average muscularity value of the set of animals. For example, the parameter may be an average of mean Body Mass Index (BMI) value of the set of animals. The function is therefore a muscularity function, or a BMI function, which calculate respectively the muscularity value or BMI value for each individual chicken received on the measurement scale based on the measured weight and measured height.

Taking a mean or average of all the chicken received on the measurement scale will render the mean or average of said muscularity value or BMI value. This represents the current muscularity (development) or BMI of the flock of chicken of the present example.

Alternatively, the parameter may comprise a distribution and/or table of the measured weights versus the measured heights.

Thus, for each respective animal 39′ of the set of animals 39, the weight and height are measured in combination, and the resulting weights and heights are subsequently used by the controller 33 to determine the parameter 38 of the set of animals 39. Since weight and height are co-measured, the present invention enables to monitor the physiological and/or the corporeal development of the set of animals 39.

For example, knowing the weight and height of each individual animal 39′, parameters such as muscularity and/or body mass index may be determined for each individual animal. Namely, a smaller chicken (indicated by height) having a higher weight is more muscular than a larger chicken (indicated by height) having a lower weight (i.e. this chicken is skinnier).

Since the set of animals 39 may be part of a larger group of animals, the determining of the parameter of the set of animals enables an approximation for the larger group of animals, which approximation may become (statistically) even more accurate as the set of animals (received on the measurement surface) increases. Hence, the determined parameter becomes more accurate as more animals step onto the scale 1 during the course of time. For a group of animals, such as a flock of chicken, the present invention may be particularly advantageous to determine the growth and physiological development of animals on a group (i.e. flock) level.

Still referring to FIG. 4, albeit optionally, the controller 33 is configured to control the light source 42 of the luminaire 40 to emit a lighting characteristic based on the determined parameter 38 of the set of animals. The lighting characteristic may for example be light color, or light intensity, or light pattern, e.g. as an indicatory light to indicate a current value of the determined parameter 38. The lighting characteristic may for example be an animal light recipe. The animal light recipe may comprise a spectral distribution of light, for example triggering a predetermined behavior of the set of animals. For example, the lighting characteristic may be visible light including a dominant peak at a wavelength range between 450-480 nm and a dominant peak at a wavelength range between 515-545 nm.

In an alternative embodiment, similar to the embodiment depicted in FIG. 4, due to the multiple pixels, such multi-pixel ToF sensor may also be able to distinguish pixels with a relatively higher value (i.e. pixels having a value exceeding a predefined threshold value) relative to background pixels, which may have a relatively low or constant value. The background pixels may correspond to the measurement surface being at a constant distance from the range sensor. Hence, the 2D footprint resulting from the pixels with a relatively higher value may be indicative of a size of the respective animal on the measurement surface. Therefore, a multi-pixel Time-of-Flight (ToF) sensor may not only be able to determine a height of a respective animal on the measurement surface, but also determine its contour or size. Therefore, in the present embodiment, the multi-pixel Time-of-Flight (ToF) sensor (i.e. range sensor) is configured to determine a size of each respective animal of the set of animals received on the measurement surface, and output a respective size signal indicative of said measured size; wherein the controller is configured to obtain each respective weight signal and each respective height signal and/or each respective size signal; and determine the parameter of the set of animals based on said measured weights and said measured heights and/or said measured sizes.

In an embodiment, similar to the embodiments depicted in FIG. 1 and FIG. 4, the same sensing system is provided, but wherein the controller is configured to: determine a first sub-parameter of the set of animals based on measured weights and measured heights obtained during a first time period; to determine a second sub-parameter of the set of animals based on measured weights and measured heights obtained during a second time period; and determine the parameter of the set of animals based said first sub-parameter and said second sub-parameter.

For example, the parameter of the set of animals may be then a growth parameter, wherein the controller is configured to: determine the first sub-parameter of the set of animals by averaging function values of a function that is using the measured weights and measured heights obtained during the first time period; determine the second sub-parameter of the set of animals by averaging function values of a function that is using the measured weights and measured heights obtained during the second time period; and determine the parameter of the set of animals by determining a difference between said first sub-parameter and said second sub-parameter.

FIG. 3 depicts schematically, by non-limiting example, a method 90 determining a parameter of a set of animals according to the invention. The method 90 is performed by a sensing system according to the invention. The sensing system comprises at least a scale, a range sensor, and a controller. The scale comprises a measurement surface suitable for receiving an animal of the set of animals, wherein the range sensor has a Field-of-View directed to said measurement surface. The method 90 comprises a step 91 of the scale measuring a weight of each respective animal of the set of animals received on a measurement surface. The method 90 comprises a step 92 of the scale outputting a respective weight signal indicative of said measured weight. The method 90 comprises a step 93 of the range sensor measuring a height of each respective animal of the set of animals received on the measurement surface. The method 90 comprises a step 94 of the range sensor outputting a respective height signal indicative of said measured height. The method 90 comprises a step 95 of the controller obtaining each respective weight signal and each respective height signal, and a step 96 of the controller determining the parameter of the set of animals based on said measured weights and said measured height.

1. A sensing system for determining a parameter of a set of animals, wherein the sensing system comprises a luminaire, a scale, a range sensor, and a controller;
wherein the range sensor is part of the luminaire;
wherein the scale comprises a measurement surface suitable for receiving an animal of the set of animals, wherein the range sensor has a Field-of-View directed to said measurement surface;
wherein the scale is configured to measure a weight of each respective animal of the set of animals received on the measurement surface, and output a respective weight signal indicative of said measured weight;
wherein the range sensor is configured to measure a height of each respective animal of the set of animals received on the measurement surface, and output a respective height signal indicative of said measured height;
wherein the controller is configured to obtain each respective weight signal and each respective height signal, and determine the parameter of the set of animals based on said measured weights and said measured heights.

2. The sensing system according to claim 1, wherein the scale is configured to convey a trigger signal to the range sensor when an animal of the set of animals is received on the measurement surface;
wherein the range sensor is configured to measure the height of each respective animal of the set of animals received on the measurement surface upon receiving said trigger signal.

3. The sensing system according to claim 2, wherein the scale comprises a radiofrequency transmitter configured to convey said trigger signal to the range sensor.

4. The sensing system according to claim 3, wherein the radiofrequency transmitter conveys said trigger signal wirelessly to the range sensor via one of: Bluetooth, ZigBee, Wi-Fi, Matter.

5. The sensing system according to claim 1, wherein the range sensor is a single-pixel Time-of-Flight (ToF) sensor.

6. The sensing system according to claim 1, wherein the parameter of the set of animals comprises a distribution and/or table of the measured weights versus the measured heights.

7. The sensing system according to claim 1, wherein the controller is configured to determine a respective function value for each respective animal of the set of animals by applying a function that is using the measured weight of each respective weight signal and the measured height of each respective height signal; and
wherein the controller is configured to determine the parameter of the set of animals by taking an average or mean of said determined function values.

8. The sensing system according to claim 7, wherein the parameter of the set of animals is an average or mean muscularity value of the set of animals.

9. The sensing system according to claim 7, wherein the parameter of the set of animals is an average or mean Body Mass Index (BMI) value of the set of animals.

10. The sensing system according to claim 1, wherein the controller is configured to:
determine a first sub-parameter of the set of animals based on measured weights and measured heights obtained during a first time period;
to determine a second sub-parameter of the set of animals based on measured weights and measured heights obtained during a second time period; and
determine the parameter of the set of animals based said first sub-parameter and said second sub-parameter.

11. The sensing system according to claim 1, wherein the set of animals is a flock of chicken.

12. The sensing system according to claim 1, wherein the luminaire is configured to power the range sensor, and/or convey control signals to the range sensor.

13. The sensing system according to claim 1, wherein the luminaire comprises a light source;
wherein the controller is configured to control the light source to emit a lighting characteristic based on the determined parameter of the set of animals.

14. A kit of parts for determining a parameter of a set of animals, wherein the kit of parts comprises a luminaire, a scale, and a controller;
wherein the scale comprises a measurement surface suitable for receiving an animal of the set of animals, wherein the scale is configured to measure a weight of each respective animal of the set of animals received on the measurement surface, and output a respective weight signal indicative of said measured weight;
wherein the luminaire comprises a range sensor;
wherein the range sensor has a Field-of-View directed to said measurement surface, wherein the range sensor is configured to measure a height of each respective animal of the set of animals received on the measurement surface, and output a respective height signal indicative of said measured height;
wherein the controller is configured to obtain each respective weight signal and each respective height signal, and determine the parameter of the set of animals based on said measured weights and said measured heights.

15. A method of determining a parameter of a set of animals, the method being performed by a sensing system comprising a luminaire, a scale, a range sensor, and a controller; wherein the range sensor is part of the luminaire;
wherein the scale comprises a measurement surface suitable for receiving an animal of the set of animals, wherein the range sensor has a Field-of-View directed to said measurement surface;
wherein the method comprises:
the scale measuring a weight of each respective animal of the set of animals received on a measurement surface;
the scale outputting a respective weight signal indicative of said measured weight;
the range sensor measuring a height of each respective animal of the set of animals received on the measurement surface;
the range sensor outputting a respective height signal indicative of said measured height;
the controller obtaining each respective weight signal and each respective height signal;
the controller determining the parameter of the set of animals based on said measured weights and said measured heights.
